(19) United States
(12) Patent Application Publication
(10) Pub. No.: US 2014/0232795 A1
(43) Pub. Date: Aug. 21, 2014

(54) RECORDING APPARATUS

(71) Applicant: SEIKO EPSON CORPORATION, Tokyo (JP)

(72) Inventor: Kenji YANAGISHITA, Matsumoto-shi (JP)

(73) Assignee: SEIKO EPSON CORPORATION, Tokyo (JP)

(21) Appl. No.: 14/172,950

(22) Filed: Feb. 5, 2014

(30) Foreign Application Priority Data
Feb. 15, 2013 (JP) 2013-028207

(51) Int. Cl. B41J 11/02; B41J 2/175

(52) U.S. Cl. CPC B41J 11/02; B41J 2/17503
USPC 347/86; 347/104

(57) ABSTRACT

A recording apparatus includes a recording unit configured to record on a medium, a supporting unit configured to support the medium, a movable unit configured to move the supporting unit with respect to the recording unit in a first direction between a set position where the recording medium is set on the supporting unit and a recording position where the recording is executed, and an operating unit configured to operate the recording unit and the movable unit. An end portion of the operating unit on the set position side in the first direction is located on the recording unit side with respect to an end portion of the supporting unit on the recording unit side in the first direction when the supporting unit is located at the set position. The operating unit overlaps at least partly with the movable unit in the second direction intersecting the first direction.

The present application claims priority to Japanese Patent Application No. 2013-028207 filed on Feb. 15, 2013, which is hereby incorporated by reference in its entirety.

### BACKGROUND

1. Technical Field

Embodiments of the present invention relate to a recording apparatus configured to perform recording on a recording medium. The workability of maintenance work or the ease with which maintenance work is performed on objects included in the apparatus is improved.

Embodiments of the recording apparatus include, by way of example and not limitation, various types of apparatuses such as ink jet printers, line printers, and copying machines.

2. Related Art

Ink jet recording apparatuses configured to discharge ink in various colors from a recording head onto a surface of a recording medium and record a desired image thereon have been developed and are widely used. Fabric, such as a T-shirt, is an example of a recording medium that has a recording surface.

An apparatus configured to record on fabric is an example of an ink jet recording apparatus. In such an apparatus, a fabric (an example of a recording medium), is placed on a platen at a default position in the front of the apparatus. After placing the fabric on the platen, the apparatus moves the platen to a position opposing the recording head provided in the apparatus body, and records an image on the recording medium (JP-A-2006-240107).

The ink jet recording apparatus is configured to transport the platen between a default position on which the recording medium is placed and a recording start position where recording on the recording medium is executed. An ink jet head is configured to perform recording on the recording medium transported to the recording start position by the platen. The platen is mounted on a platen supporting bed. The platen supporting bed is configured to move along a rail provided on a base extending from the inside of the apparatus body to the front of the apparatus along the direction of transport of the platen.

The ink jet head is mounted on a carriage configured to reciprocate in the width direction of the apparatus body so as to oppose the platen. The width direction intersects the direction of transport of the recording medium.

In ink jet recording apparatuses, a flushing operation is an operation that causes ink to be discharged from the nozzles toward a flushing pad. The flushing pad is arranged outside of a printing area in the width direction of the apparatus body. The flushing operation is performed in order to prevent the nozzles from being clogged by ink that is adhered to or left in the nozzles. The flushing pad absorbs the ink discharged from the nozzles by the flushing operation. As a result, the flushing pad needs to be replaced in accordance with the number of times the flushing operation is executed.

Outside the recording area in the width direction of the apparatus body on a side opposite to the side where the flushing pad is provided, a wiper is provided. The wiper is configured to clean a nozzle surface of the recording head. The wiper scrapes ink that has adhered to the nozzle surface and that may have increased in viscosity off of the nozzle surface. The wiper scrapes the ink off the nozzle surface when the carriage moves in the width direction of the apparatus body.

A cap configured to protect the nozzle surface when the carriage is located at a home position is also provided. The cap protects the nozzle surface of the recording head when the carriage is at the home position and simultaneously sucks ink remaining in the nozzle. The sucked ink is absorbed by an ink absorbing member disposed in the cap. Therefore, in order to maintain the ink discharging performance of the nozzle, it is necessary to regularly clean the wiper and replace the ink absorbing member of the cap.

The ink jet recording apparatus has an ink cartridge storing portion in which an ink cartridge configured to supply ink to the ink jet head is stored. The ink cartridge requires regular replacement.

Therefore, the ink jet recording apparatus requires regular maintenance work such as cleaning and/or replacement of the flushing pad, the wiper, and the cap provided in the apparatus body. The regular maintenance may also include replacing the ink cartridge.

The ink jet recording apparatus described in JP-A-2006-240107 is provided with an operating panel on a side of the base. The operating panel is configured to operate the recording apparatus. However, in this configuration, the size of the ink jet recording apparatus is increased. In addition, a space needed for installing the ink jet recording apparatus is increased. In addition, since the operating panel is arranged on one side in the width direction of the apparatus, a user experiences difficulty in operating the operating panel from the other side of the apparatus in the width direction. Therefore, workability of the ink jet recording apparatus is lowered.

Further, the ink jet recording apparatus is provided with a base. The base projects forward from the apparatus body. As a result, the base obstructs the user from accessing the apparatus in proximity thereof when the user performs maintenance work from the front side of the apparatus. Therefore, the user is obliged to perform maintenance work by extending his or her arms and reaching out with his or her hands. In addition, the user has difficulty in seeing work points and is therefore obliged to work in a stressful position. Therefore, the ease with which maintenance work is carried out is lowered and workability is reduced.

In addition, an area around the ink jet recording apparatus needs to be secured in order to allow the user access to the apparatus for maintenance work. Consequently, the area used for installing the ink jet recording apparatus may need to be increased.

Furthermore, the ink cartridge storage portion in which the ink cartridges are stored may present an obstacle when setting fabric in the ink jet recording apparatus.

In order to reduce the space required for installing the ink jet recording apparatus and improve the workability or the ease with which maintenance is performed, the operating panel could be arranged at a center portion of the apparatus in the width direction. However, when the operating panel is arranged at the center portion, at least part of the operating panel is positioned above the base. And the base extends forward from the apparatus body.

Therefore, when an attempt is made to set the recording medium on the platen supporting bed with the platen supporting bed positioned at the set position on the front side of the apparatus, the recording medium and the operating panel positioned above the base interfere with each other and the ability to smoothly set the recording medium on the platen supporting bed may be hindered. Accordingly, the workability of setting the recording medium on the platen supporting bed may be lowered.

### SUMMARY

Embodiments of the invention relate to a recording apparatus in which maintenance work is facilitated and an installation space required for installation is reduced in size.

An example of a recording apparatus includes a recording unit configured to record on a recording medium (e.g., by ejecting a liquid onto the recording medium), a supporting unit configured to support the recording medium, a movable unit configured to move the supporting unit with respect to the recording unit in a first direction between a set position where the recording medium is set or placed on the supporting unit and a recording position where the recording is executed, and an operating unit configured to operate the recording unit and the movable unit.

An end portion of the operating unit on the set position side in the first direction is located on the recording unit side with respect to an end portion of the supporting unit on the recording unit side in the first direction. The operating unit overlaps at least partly with the movable unit in a second direction intersecting the first direction in a state in which the supporting unit is located at the set position.

In this configuration, the end portion of the operating unit on the set position side in the first direction is located on the recording unit side with respect to an end portion of the supporting unit on the recording unit side in the first direction when the supporting unit is located at the set position. Accordingly, the recording apparatus is configured to reduce the risk of or prevent an interference between the recording medium and the operating unit when the recording medium is set to the supporting unit. In one example, the operating unit is located on a front surface and is located such that the operating unit does not interfere with the placement of a recording medium on a supporting unit when the supporting unit is in the set position.

The operating unit overlaps at least partly with the movable unit in a second direction intersecting the first direction in a state in which the supporting unit is located at the set position. Therefore, for example, when the operating unit is arranged at a center of the recording apparatus in the second direction together with the movable unit, the operating unit can be operated from both sides of the movable unit in the second direction and workability is facilitated. In addition, a working area needed for operating the operating unit may be reduced in comparison with a case where the operating unit is provided on the side of the recording apparatus. As a result, a reduction of the size of the apparatus by itself is achieved.

The term “maintenance operation” or “maintenance” includes, but is not limited to, not only cleaning or replacement of a flushing pad, a wiper and a cap, but also maintenance relating generally to the recording unit such as maintenance of a carriage, removal of a jammed recording medium, and replacing ink cartridges.

The recording unit may include a housing. A recording head is provided in the interior of the housing. An end portion of the housing on the set position side in the first direction is located on the recording head side with respect to an end portion of the supporting unit in the first direction.

In this example, in a state in which the supporting unit is located at the set position, the end portion of the housing on the set position side in the first direction is located on the recording head side with respect to the end portion of the supporting unit on the recording unit side in the first direction. Therefore, when the recording medium is set on the supporting unit, the risk of interference between the recording medium and the housing is reduced, or prevented.

In one example, the length from one end portion of the housing to the movable unit in the second direction is longer than the length from an end portion of the housing on the other side to the movable unit in the second direction.

In this example, the length from one end portion of the housing to the movable unit in the second direction is longer than the length from an end portion of the housing on the other side to the movable unit in the second direction. Therefore, the user can easily access the end portion on at least one side of the housing. The workability of the maintenance operation or the ease with which the maintenance operation is performed at the end portion is improved.

The recording unit may be provided with the recording head and an ink cartridge storage portion (e.g., an ink storage portion that can be inserted into the storage unit). The ink storage portion may be configured for storing ink to be supplied to the recording head. When the ink storage portion is stored in the storage unit, an end portion of the ink storage portion on the set position side in the first direction is located on the recording head side with respect to an end portion of the supporting unit on the recording unit side in a state in which the supporting unit is located at the set position.

In this example, in a case where the ink storage portion is stored in the storage portion, the end portion of the ink storage portion on the set position side in the first direction is located on the recording unit side with respect to the end portion of the supporting unit on the recording unit side in a state in which the supporting unit is located at the set position. Therefore, when the recording medium is set on the supporting unit, the risk of interference of the recording medium with the ink storage portion is reduced, or prevented.

The storage unit includes a first storage unit provided on one side in the second direction and a second storage unit provided on the other side in the second direction. The movable unit is located between the first storage unit and the second storage unit in the second direction.

In this example, since the first storage portion is provided on one side of the movable unit and the second storage portion is provided on the other side thereof in the second direction, the operation of the operating unit and replacement work for the ink storage portion are achieved on both sides of the movable unit. Accordingly, the necessity of providing working spaces separately around the recording apparatus is eliminated, so that the reduction of the size of the apparatus by itself is achieved.

The storage unit may include an openable-and-closable cover. The openable-and-closable cover in the closed state is located on the recording head side with respect to an end portion of the supporting unit on the recording unit side in the first direction.

In this configuration, since the openable-and-closable space of the openable-and-closable cover may be used as the operation working areas for operating the operating unit on both side of the movable unit, the necessity of provisioning the openable-and-closable space for the openable-and-closable cover around the recording apparatus is eliminated. An installation space of the recording apparatus may be reduced.

The recording unit may be provided with a see-through portion configured to make the interior thereof visible from the outside or from the exterior.

In this example, since the recording unit is provided with the see-through portion which allows the interior to be seen, the workability of maintenance work is improved and a recording execution condition for the recording medium in the recording unit may be visually confirmed when performing maintenance work on the recording unit on both sides of the movable unit.

The see-through portion may be provided with a transparent openable-and-closable cover. In this example, visibility of the interior of the recording unit from both sides of the movable unit is improved. The “transparent cover” may include not only a colorless transparent cover, but also covers configured to make the interior of the recording unit visible from the outside of the recording unit even though the transparent cover is colored or not completely transparent.

The length of the transparent openable-and-closable cover in the second direction may be longer than the length of the movable unit in the second direction.

### BRIEF DESCRIPTION OF THE DRAWINGS

Embodiments of the invention will be described with reference to the accompanying drawings wherein like numbers reference like elements.

FIG. 1 is a perspective view of an example of a recording apparatus.

FIG. 2 is a side view of an example of the recording apparatus.

FIG. 3 is a perspective view of the recording apparatus and illustrates a state in which a cover in a see-through portion is opened.

FIG. 4 is a perspective view of the recording apparatus and illustrates an object that requires maintenance corresponding to a first area.

FIG. 5 is a perspective view of the recording apparatus and illustrates an object that requires maintenance corresponding to a first area.

FIG. 6 is a plan view of an area in the recording apparatus.

FIG. 7 is a perspective view of the recording apparatus and illustrates a state in which an openable-and-closable cover is opened in an ink cartridge storage portion.

### DESCRIPTION OF EXEMPLARY EMBODIMENTS

In an X-Y-Z coordinate system illustrated in the respective drawings, an X-direction indicates a direction of transport (a transport direction) of a recording medium, a Y-direction indicates a scanning direction of a carriage, and a Z-direction indicates a height direction of the apparatus (perpendicular direction). In the respective drawings, a −X direction side is defined as a front side of the apparatus and a +X direction is defined as a rear side of the apparatus.

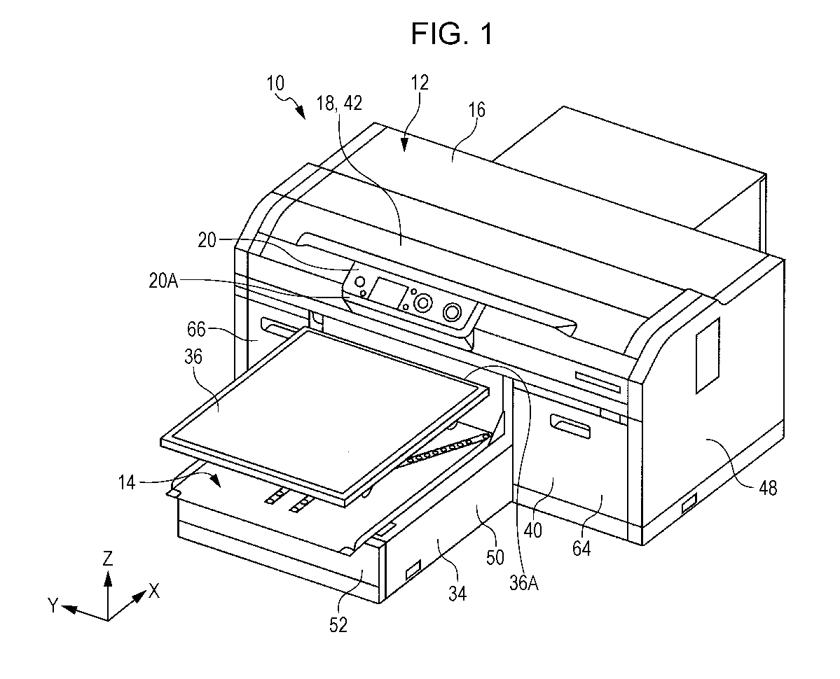

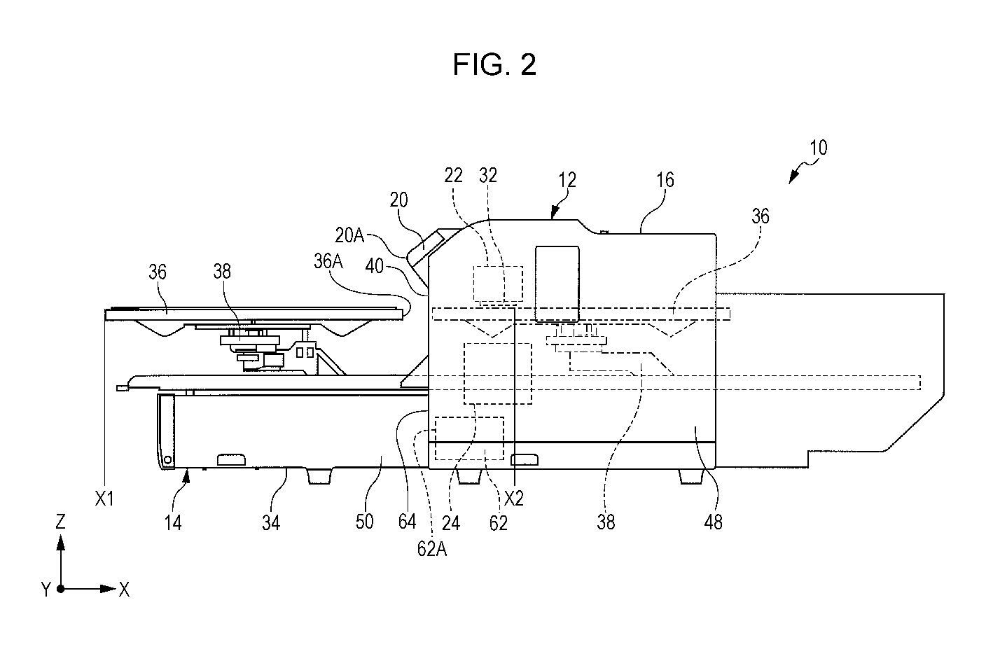

Referring now to FIG. 1 and FIG. 2, a general configuration of a printer 10 will be described. The printer 10 includes a recording unit 12, and a movable unit 14 projecting from the recording unit 12 toward the front of the apparatus, that is, in the −X direction.

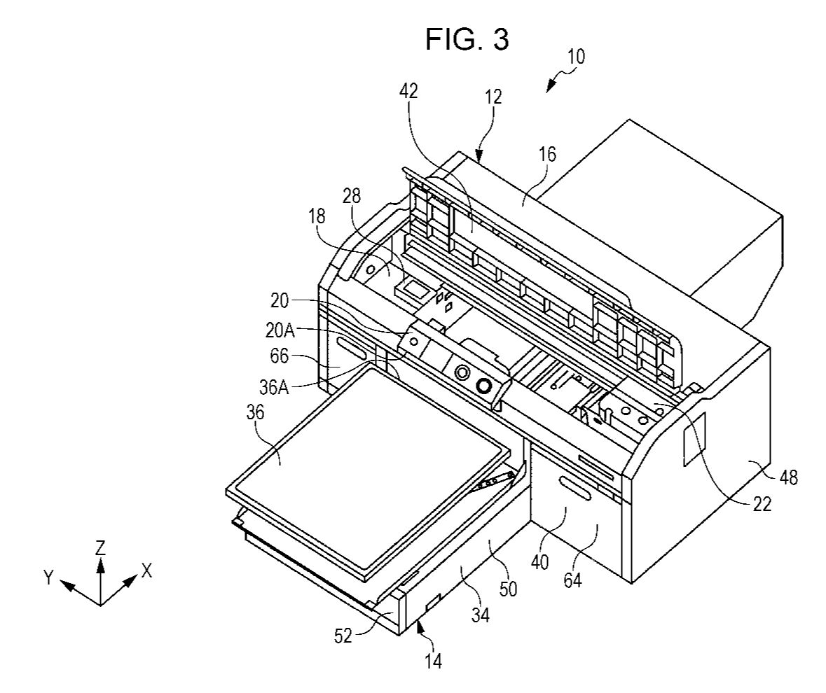

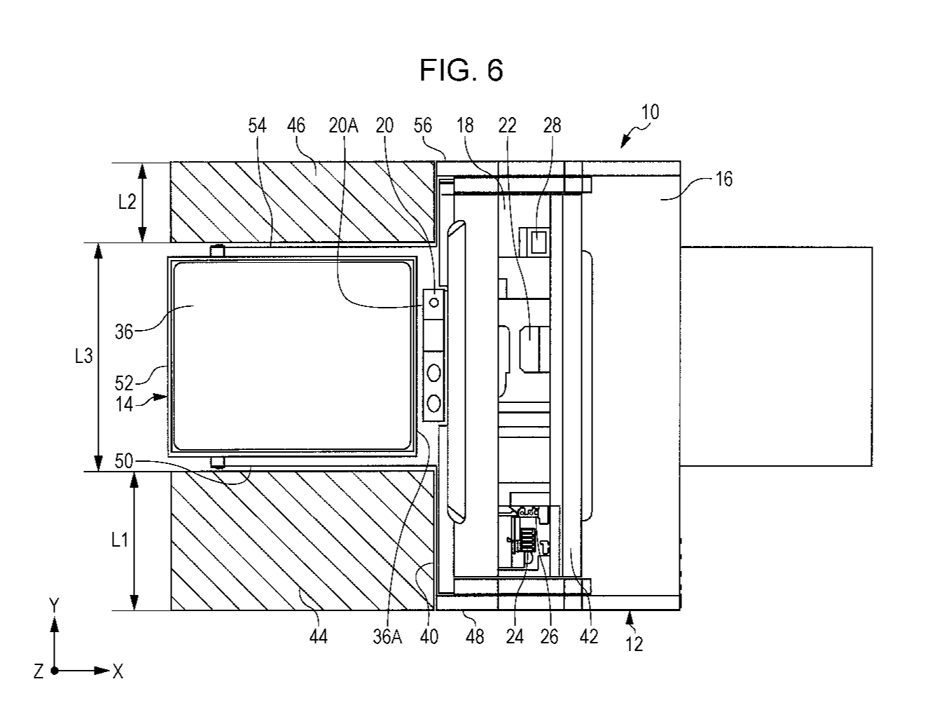

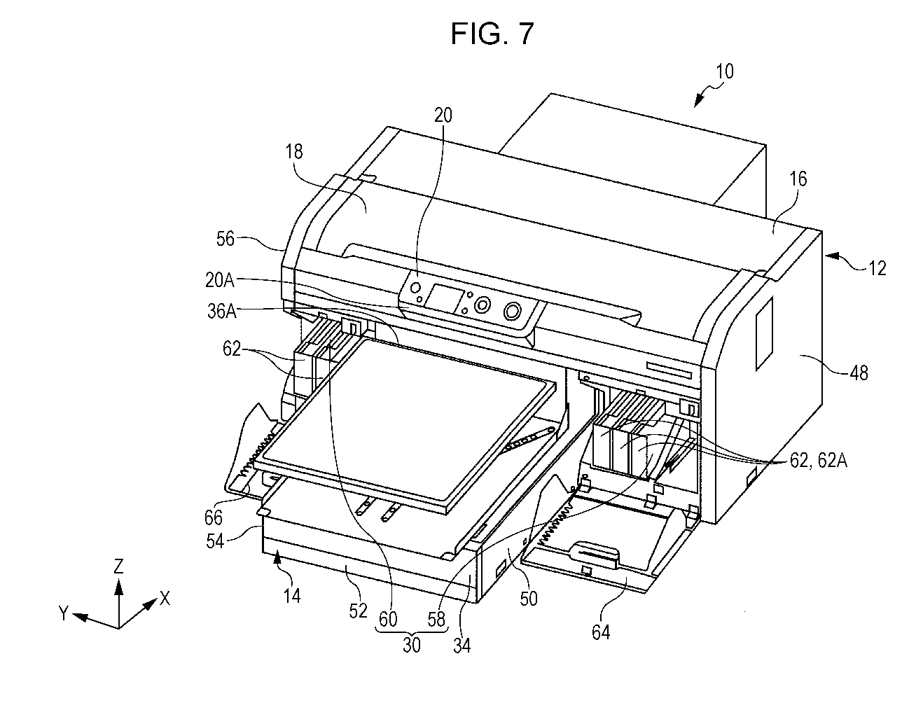

The recording unit 12 includes a housing 16, a see-through portion 18, an operating unit 20, and a carriage 22. The recording unit 12 includes a cap 24, a wiper 26 (see FIG. 6), a flushing pad 28 (see FIG. 3), and an ink cartridge storage portion 30 (see FIG. 7). The ink cartridge storage portion 30 may be on the outside of a recording area in a movable area of the carriage 22.

The see-through portion 18 provided in the housing 16 makes the interior of the recording unit 12 visible from the outside. The housing 16 is provided with an operating unit 20. In one example, the operating unit 20 includes operating switches and a liquid crystal panel and the like for operating the printer 10.

When the tray 36 is positioned at a set position X1 in the X-axis direction (described later), the operating unit 20 is located on a recording head 32 side with respect to an end portion 36A of a tray 36. When the tray 36 is moved to the set position X1, the tray 36 is moved in the −X direction. In other words and as illustrated in FIG. 2, when the tray 36 is located at the set position X1, the tray 36 and the operating unit 20 do not overlap in the perpendicular direction. In the X axis direction, the operating unit 20 is between the recording head 32 and the end portion 36A of the tray 36.

When setting the recording medium on the tray 36 that is at the set position X1, there is no risk or less risk that a user will operate the operating unit 20 erroneously. In other words, the operating unit 20 is arranged such that the operating unit 20 does not interfere with placement of the recording medium on the tray, reduces risk that the operating unit 20 will be operated erroneously, and does not interfere with maintenance of objects or components of the printer 10. Advantageously, an erroneous operation of the printer 10 is prevented and maintenance work is facilitated.

Furthermore, the recording unit 12 includes a carriage 22 having a primary scanning direction in the Y-axis direction. The carriage 22 is configured to be movable in the primary scanning direction in the interior of the housing 16. The carriage 22 includes a recording head 32 configured to discharge ink at a lower portion thereof.

The movable unit 14 includes a base 34, the tray 36 which functions as a “supporting unit”, and a moving mechanism 38. The base 34 projects from the recording unit 12 forward and rearward of the recording unit 12, and extends in the X-axis direction. In this manner, the base 34 projects partly from a front surface 40 side of the recording unit 12. Furthermore, the moving mechanism 38 is configured to move the tray 36 along the X-axis direction and is provided on an upper surface of the base 34. The moving mechanism 38 is driven by a drive source.

The tray 36 reciprocates between a set position X1 (see a solid line in FIG. 2) and a recording start position X2 (see dashed line portion in FIG. 2). The set position X1 of the tray 36 is when the tray 36 is positioned on the front surface 40 side of the recording unit 12 and the recording start position X2 of the tray 36 is when the tray 36 is positioned in the interior of the recording unit 12. The user sets a recording medium such as a T-shirt on the tray 36 when the tray 36 is at the set position X1. As illustrated in FIG. 2, when the tray 36 is positioned at the set position X1, an end portion 20A of the operating unit 20 is located on the recording unit 12 side with respect to the end portion 36A of the tray 36 positioned at the set position X1. In one example, the end portion 20A is between the tray 36 and the recording unit 12 when the tray 36 is positioned at the set position X1. Therefore, when setting the recording medium on the tray 36 when the tray 36 is located at the set position X1, interference of the operating unit 20 with the recording medium is suppressed, or prevented. The operating unit 20 is positioned on the printer 10 such that a user can set the recording medium on the tray 36 without interference from the operating unit 20 or from the end portion 20A of the operating unit 20.

After the user has set the recording medium on the tray 36, the operating unit 20 is operated to move the tray 36 to the recording start position X2. While the tray 36 moves from the set position X1 to the recording start position X2, the recording head 32 provided on the lower portion of the carriage 22 is retracted to a home position, which will be described later. FIG. 2 illustrates a state in the course of a recording process on the recording medium placed on the tray 36.

When the tray 36 moves from the set position X1 to the recording start position X2, the carriage 22 is driven and ink is discharged from the recording head 32 to the recording medium set on the tray 36. After the recording has terminated, the tray 36 is moved to the set position X1 and the recording medium can be removed. The description given thus far is an outline of the printer 10 and a detailed configuration of the printer 10 will now be described.

Referring to FIG. 3, the housing 16 is provided with the see-through portion 18. The see-through portion 18 is used by the user to see the carriage 22 and the movable area of the carriage 22 in the interior of the housing 16 from the outside of the housing 16. The viewable or see-through portion 18 is provided with a cover 42 which is openable and closable with respect to the housing 16. In one example, the cover 42 is configured to be longer than a length of the movable unit 14 in the Y-axis direction as illustrated in FIG. 3.

The cover 42 may be transparent and may allow the user to see the interior of the housing 16 from the outside thereof. Here, “transparent” does not have to be completely transparent as long as the user can see the interior of the housing 16 from the outside. For example “transparent” means here that a visible light transmission of the openable-and-closable cover 42 is 30 to 100% inclusive in one example. Alternatively, the cover 42 may also be opened to provide a view of the interior of the housing 16 from the outside.

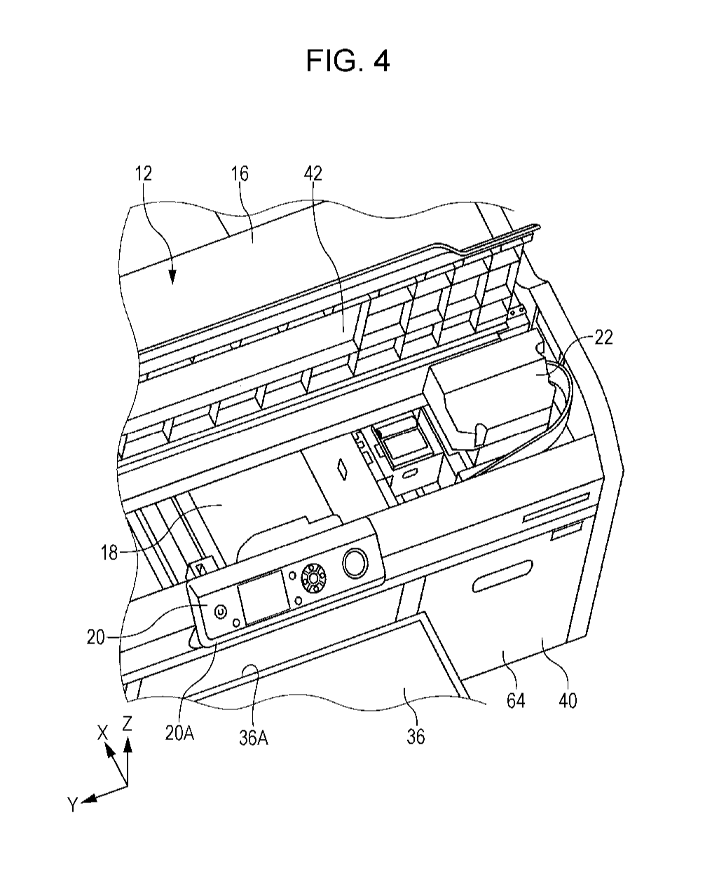

Referring further to FIG. 4, the carriage 22 is configured to be movable along the Y-direction in the housing 16. The Y-direction corresponds to the primary scanning direction. When the carriage 22 is in a non-recording state, the carriage 22 is moved to a home position. The home position is located outside of the recording area in the movable area of the carriage 22 on one side as illustrated in FIG. 4. In this embodiment, the home position is located on the −Y side, which corresponds to the movable area outside of the recording area.

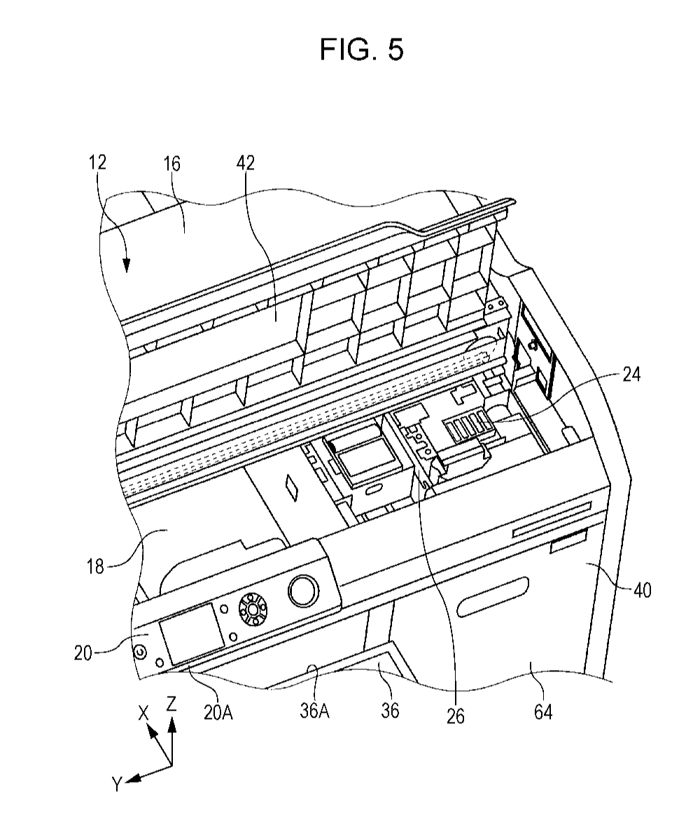

Referring now to FIG. 5, the cap 24 and the wiper 26, which are first objects of maintenance, are provided below the carriage 22 at the home position in the housing 16. In other words, the cap 24 and the wiper 26 are examples of objects or components of the printer 10 that require maintenance.

The cap 24 presses against the recording head 32 from below when the carriage 22 is located at the home position, and protects a nozzle surface by covering ink discharge nozzles, of the recording head 32.

Furthermore, an ink absorbing member is provided in the cap 24. Ink remains in the ink discharge nozzles after the recording operation has been executed, and the viscosity of the ink remaining in the ink discharge nozzles increases. Therefore, when time has elapsed in this state, the ink discharge nozzles may be clogged by the remaining higher viscosity ink. When the cap 24 covers the recording head 32 in the home position, air in the cap 24 is sucked by a pump connected to the recording head or the cap. As a result, the inside of the cap has a negative pressure. Consequently, the ink remaining in the ink discharge nozzles is sucked from the inside of the ink discharge nozzles, and is absorbed by the ink absorbing member. Accordingly, the ink discharge nozzles are prevented from being clogged by the remaining high viscosity ink.

The wiper 26 is provided at the home position. The wiper 26 is arranged at a position adjacent to the cap 24. The wiper 26 is arranged so as to scrape the nozzle surface of the recording head 32 when the carriage 22 moves to and/or from the home position in the primary scanning direction. For example, when the carriage 22 moves in the Y-axis direction, or from a position on the +Y side with respect to the home position to the home position, the wiper 26 is configured to wipe the nozzle surface. The wiper 26 may be configured to include a blade member extending in the X-axis direction.

When the remaining ink in the ink discharge nozzle is sucked from the ink discharge nozzles by the cap 24, part of the sucked ink may adhere to the nozzle surface of the recording head 32. Also, some of the ink discharged from the recording head 32 is transformed into ink mist that floats in the interior of the printer 10. Some of the ink mist may adhere to the nozzle surface.

The ink that has adhered to the nozzle surface becomes more viscous with time. The ink may solidify and adhere to the nozzle surface. Therefore, after the ink has been sucked by the cap 24 or after the ink has been discharged from the recording head 32, the nozzle surface and the wiper 26 are moved relative to each other in a state in which the wiper 26 is kept in contact with the nozzle surface. By keeping the wiper in contact with the nozzle surface during the relative movement of the wiper 26 and the nozzle surface, ink that has adhered to the nozzle surface is wiped off of the nozzle surface. The adhesion and/or solidification of ink on the nozzle surface is prevented.

Referring now to FIG. 3, the flushing pad 28, which is another example of an object or component of the printer 10 that requires maintenance, is provided in the movable area of the carriage 22 outside of the recording area on the other side. More specifically in one example, the cap and wiper are on a first side of the recording area and the flushing pad 28 is on a second side of the recording area in the Y axis direction. More specifically, the flushing pad 28 may be arranged in the movable area on the outside of the recording area, that is, in the movable area on the side opposite from the side where the cap 24 and the wiper 26 are provided. The flushing pad 28 is provided with the ink absorbing member.

In general, in the printer 10, which may be an ink jet printer, flushing is required. Flushing causes ink to be discharged regularly from the ink discharge nozzles in order to prevent the nozzles from being clogged by high viscosity ink or by the ink that has adhered to the nozzles of the recording head 32. A flushing operation or flushing is performed by moving the carriage 22 to a position above the flushing pad 28 and by causing the ink to be discharged from the ink discharge nozzles. Flushing may be performed, for example, after the recording operate (e.g., after discharging ink onto a recording medium to form an image on the recording medium) has been performed a predetermined number of times or at the time of power activation of the printer 10 (e.g., when the printer is turned on or when the printer has been in an inactive state for a predetermined period of time).

When the carriage 22 is moved to the position right above the flushing pad 28 and the flushing is performed, the ink discharged from the ink discharge nozzles of the recording head 32 is absorbed by the ink absorbing member of the flushing pad 28.

The ink absorbing member provided in the cap 24 and the ink absorbing member of the flushing pad 28, being configured to absorb the ink, need to be replaced regularly. The wiper 26 also needs to be washed regularly to remove the ink that the wiper 26 has scraped off the nozzle surface. The wiper 26 itself sometimes needs to be replaced.

Referring now to FIG. 6, a first area 44 used for maintenance work is provided at a position corresponding to the cap 24 and the wiper 26 on or next to the front surface 40 of the recording unit 12. The cap 24 and the wiper 26 are examples of first objects than may require maintenance. A second area 46 used for maintenance work is also provided at a position corresponding to the flushing pad 28 on or next to the front surface 40 of the recording unit 12. The flushing pad 28 is an example of a second object that may require maintenance.

Furthermore, the movable unit 14 is positioned between the first area 44 and the second area 46 in the Y-axis direction on or next to the front surface 40 of the recording unit 12. In other words, the first area 44 and the second area 46 are provided on the two sides of the movable unit 14. More specifically, the first area 44 and the second area 46 are provided on the two sides of the movable unit 14 in the Y axis direction. The movable unit 14 may be between the first area 44 and the second area 46.

In one example, the first area 44 corresponds to an area between a right side surface 48 of the housing 16 and a right side surface 50 of the movable unit 14 in the Y-axis direction and between the front surface 40 of the housing 16 (the recording unit 12) and the distal end 52 of the movable unit 14 in the X-axis direction. The first area 44 facilitates maintenance work (e.g., washing work and replacement work) of the cap 24 and the wiper 26, which correspond to the first objects that may require maintenance.

In the Y-axis direction, the length of the first area 44 is defined as L1, the length of the second area 46 is defined as L2, and the length of the movable unit 14 is defined as L3 as illustrated in FIG. 6. The length of the housing 16 is expressed as L1+L2+L3. The relationship between the length L1 of the first area 44 and the length L2 of the second area 46 is expressed as L2<L1 in one example.

Therefore, the user is allowed to perform maintenance work for the cap 24 and the wiper 26 at a position close to the cap 24 and the wiper 26 by entering the first area 44. The printer 10 is configured, in one example, such that the first area 44 provides access to objects that require maintenance. The tray 36 and the operation unit 20 do not interfere with the maintenance performed for the first objects.

In the same manner, in order to facilitate maintenance work for the flushing pad 28, the second area 46 corresponds to an area between a left side surface 54 of the movable unit 14 and the left side surface 56 of the housing 16 in the Y-axis direction and between the front surface 40 of the housing 16 (the recording unit 12) and the distal end 52 of the movable unit 14 in the X-axis direction.

Therefore, the user is allowed to enter the second area 46 and perform maintenance work (e.g., replacement work) on the flushing pad 28 at a position close to the flushing pad 28. The printer 10 is configured, in one example, such that the second area 46 provides access to second objects that require maintenance. The tray 36 and the operation unit 20 do not interfere with the maintenance performed for the second objects.

The user, being allowed to enter the first area 44 and the second area 46 for the maintenance operations, is capable of performing maintenance work for the cap 24 and the wiper 26 and the flushing pad 28 and/or other objects. In addition, maintenance work for the carriage 22 and the recording head 32 and maintenance work for troubles in the recording start position X2 may also be performed by accessing these objects or locations through the area 44 or the area 46. In addition, the user is also allowed to confirm a recording condition of the recording medium via the see-through portion 18. The user can see inside the housing 16 and monitor the recording operation. Therefore, the first area 44 and the second area 46 function also as a visible check area for the see-through portion 18.

In one embodiment, since the frequency of maintenance work required for the cap 24 and the wiper 26 may be higher than the frequency of maintenance required for the flushing pad 28, the length L1 of the first area 44 (see FIG. 6) is set to be larger than the length L2 of the second area 46 (see FIG. 6) in the Y-axis direction or in the width direction of the front surface 40 of the recording unit 12. The length L1 and the length L2 may be set with workability and accessibility or frequency of accessibility in mind.

Referring now to FIG. 7, the front surface 40 of the recording unit 12 is provided with an ink cartridge storage portion 30 as a “storage portion” or a storage unit. The ink cartridge storage portion 30 includes a first ink cartridge storage portion 58 provided at a position corresponding to the first area 44, on the front surface 40 of the recording unit 12. The ink cartridge storage portion 30 may also include and a second ink cartridge storage portion 60 provided at a position corresponding to the second area 46 on the front surface 40 of the recording unit 12.

The first ink cartridge storage portion 58 and the second ink cartridge storage portion 60 allow a plurality of ink cartridges 62 to be stored or mounted therein as “ink storage portions”. Therefore, the first area 44 and the second area 46 also function as working areas for storing the ink cartridges 62 in the first ink cartridge storage portion 58 and the second ink cartridge storage portion 60. In other words, the first area 44 and the second area 46 allow the ink cartridges 62 to be stored in the ink cartridge storage portion 30 and allow the ink cartridges 62 to be replaced.

As illustrated in FIG. 2, in the ink cartridges 62 stored in the first ink cartridge storage portion 58 and in the second ink cartridge storage portion 60, the end portions 62A on the front surface 40 side of the recording unit 12 are located on the recording unit 12 side with respect to the end portion 36A of the tray 36 in the X-axis direction in FIG. 2 when the tray 36 is located at the set position X1.

The first ink cartridge storage portion 58 is provided with a first openable-and-closable cover 64 on the front surface 40 of the recording unit 12. The first openable-and-closable cover 64 is configured to be rotatable with respect to the front surface 40, and is configured to switch the first ink cartridge storage portion 58 between the opened state and the closed state. Therefore, the first area 44 also functions as an openable-and-closable area of the first openable-and-closable cover 64. For example, one end of the cover may be connected to the front surface 40 while a second end of the cover 64 can be pulled away from the front surface 40.

In the same manner, the second ink cartridge storage portion 60 is provided with a second openable-and-closable cover 66 on the front surface 40 of the recording unit 12. The second openable-and-closable cover 66 is configured to be rotatable with respect to the front surface 40, and is configured to switch the second ink cartridge storage portion 60 between the opened state and the closed state. Therefore, the second area 46 also functions as an openable-and-closable area of the second openable-and-closable cover 66. For example, one end of the cover 66 may be connected to the front surface 40 while a second end of the cover 66 can be pulled away from the front surface 40.

The first openable-and-closable cover 64 and the second openable-and-closable cover 66 in the closed state are positioned on the recording head 32 side with respect to the end portion 36A of the tray 36 on the recording head 32 side in the X-axis direction when the tray 36 is positioned at the set position X1. Accordingly, when the recording medium is set to or loaded on the tray 36, contact between the recording medium and the respective openable-and-closable covers may be suppressed or avoided. In other words, the printer 10 is configured such that access to objects or components of the printer is enabled even when a recording medium is being loaded or when the tray 36 is in the set position X1 or the recording position X2.

As a summary of the above-described description, the printer 10 of the embodiment includes the recording unit 12. The recording unit 12 is configured to perform printing or to print on the printing or recording medium. The tray 36 is configured to support the printing medium. The movable unit 14 is configured to move the tray 36 in the X-axis direction with respect to the recording unit 12 between the set position X1 where the recording medium is set on the tray 36 and the recording start position X2 where the recording is executed (using the recording unit 12) on the recording medium supported on the tray 36. The operating unit 20 is configured to operate or control the recording unit 12 and the movable unit 14. The end portion 20A of the operating unit 20 on the set position X1 side in the X-axis direction is located on the recording unit 12 side with respect to the end portion 36A of the tray 36 on the recording unit 12 side in the X-axis direction in a state in which the tray 36 is located at the set position X1. The operating unit 20 may overlap with the movable unit 14 at least partly in the Y-axis direction or the Z-axis direction intersecting the X-axis direction.

The recording unit 12 includes the housing 16. The recording head 32 is provided in the housing 16. An end of the housing 16 on the set position X1 side in the X-axis direction, that is, the front surface 40 of the housing 16, is located on the recording head 32 side with respect to the end portion 36A of the tray 36 on the recording unit 12 side in the X-axis direction in a state in which the tray 36 is located at the set position X1. In other words, the front surface 40 is between the recording head 32 and the end portion 36A of the tray 36 when the tray 36 is located at the set position X1.

In the housing 16, the length L1 from the right side surface 48 of the housing 16 to the movable unit 14 in the Y-axis direction is longer than the length L2 from the left side surface 56 of the housing 16 to the movable unit 14 in the Y-axis direction. The recording unit 12 is provided with the recording head 32 and the ink cartridge storage portion 30. The ink cartridges 62 for storing ink to be supplied to the recording head 32 are stored in the ink cartridge storage portion 30. When the ink cartridges 62 are stored in the ink cartridge storage portion 30, the end portion 62A of the ink cartridges 62 on the set position X1 side in the X-axis direction is located on the recording unit 12 side with respect to the end portion 36A of the tray 36 on the recording unit 12 side in a state in which the tray 36 is located at the set position X1.

The ink cartridge storage portion 30 includes the first ink cartridge storage portion 58 provided on one side of the printer 10 in the Y-axis direction, and the second ink cartridge storage portion 60 provided on the other side of the printer 10. The movable unit 14 is located between the first ink cartridge storage portion 58 and the second ink cartridge storage portion 60 in the Y-axis direction. The ink cartridge storage portion 30 includes openable-and-closable covers 64 and 66. The openable-and-closable covers 64 and 66 in the closed state are positioned on the recording unit 12 side with respect to the end portion 36A of the tray 36 on the recording head 32 side in the X-axis direction when the tray 36 is positioned at the set position X1. The covers 64 and 66 are provided on the front surface 40.

The recording unit 12 includes the see-through portion 18. The see-through portion allows the user to see the interior thereof. The see-through portion 18 includes the transparent openable-and-closable cover 42. The length of the openable-and-closable cover 42 in the Y-axis direction is longer than the length of the movable unit 14 in the Y-axis direction.

Aspects of the printer 10 may be modified. For example, (1) the see-through portion 18 may be configured as a colored transparent cover instead of a colorless and transparent cover, and may be replaced by an opening without providing the openable-and-closable cover 42.

(2) In one embodiment, the cap 24 and the wiper 26 are arranged on the −Y side of the movable area of the recording unit 12. However, the cap 24 and the wiper 26 may be arranged on the +Y side of the movable area. The flushing pad 28 may be arranged on the −Y side of the movable area instead of the +Y side of the movable area of the recording unit 12. (3) The wiper 26 may be configured in the form of a brush or a fabric in addition to or instead of the blade member.

(4) The first openable-and-closable cover 64 of the first ink cartridge storage portion 58 and the second openable-and-closable cover 66 of the second ink cartridge storage portion 60 may be configured to be a demountably mountable type cover instead of the openable and closable type cover.

(5) In one example, the first openable-and-closable cover 64 and the second openable-and-closable cover 66 are not provided. In this case, the end portions 62A of the ink cartridges 62 in the X-axis direction stored in the first ink cartridge storage portion 58 and the second ink cartridge storage portion 60 may be located on the recording head 32 side of the end portion 36A of the tray 36 on the recording head 32 side in the X-axis direction when the tray 36 is located at the set position X1. Accordingly, when setting the recording medium on the tray 36, contact between the recording medium and the ink cartridges 62 may be suppressed or prevented.

(6) The ink cartridge storage portion 30 has a configuration in which the first ink cartridge storage portion 58 and the second ink cartridge storage portion 60 are provided. In one example, only one of the ink cartridge storage portion 30 (e.g., the first ink cartridge storage portion 58) is provided.

(7) In one embodiment, the moving mechanism 38 moves the tray 36 in the X-axis direction. However, the printer 10 may be configured such that the recording head 32 and the carriage 22 are moved in the X-axis direction and the Y-axis direction with respect to the tray 36. In another example, both the tray 36 and the carriage 22 are configured to be moved in the X-axis direction and/or the Y-axis direction.

In addition, in one embodiment, the printer 10 may be an ink jet printer, which is an example of the recording apparatus. However, embodiments of the invention may be applied generally to other liquid ejection apparatuses. Embodiments of the liquid ejection apparatus include not only recording apparatuses such as printers, copying machines or facsimiles, which use an ink jet recording head and which record on a recording medium by ejecting ink from the recording head, but also apparatuses configured to eject liquid corresponding to the application thereof instead of ink from a liquid ejection head corresponding to the ink jet recording head to an ejected medium corresponding to the recording medium to cause the liquid to be adhered to the recording medium.

Examples of the liquid ejection head include a color material ejection head used for manufacturing color filters such as liquid crystal displays or the like, an electrode material (e.g., conductive paste) ejecting head used for forming electrodes of organic EL displays or surface emission-type displays (FED) or the like, a biological organic substance ejecting head used for manufacturing biochips, and a sample ejecting head as a precision pipette in addition to the recording head.

Embodiments of the invention are not limited to the embodiments described above, and various modifications may be made within the scope of the invention described in the appended claims and, needless to say, such modifications are also included in the invention.

What is claimed is:

1. A recording apparatus comprising:
a recording unit configured to record on a recording medium;
a supporting unit configured to support the recording medium;
a movable unit configured to move the supporting unit with respect to the recording unit in a first direction between a set position where the recording medium is set on the supporting unit and a recording position where the recording is executed by the recording unit; and
an operating unit configured to operate the recording unit and the movable unit, wherein
an end portion of the operating unit on a set position side in the first direction is located on a recording unit side with respect to an end portion of the supporting unit on the recording unit side in the first direction, and
the operating unit overlaps at least partly with the movable unit in a second direction intersecting the first direction in a state where the supporting unit is located at the set position.

2. The recording apparatus according to claim 1, wherein
the recording unit includes a housing and a recording head is provided in an interior of the housing; and
an end portion of the housing on the set position side in the first direction is located on a recording head side with respect to an end portion of the supporting unit in the first direction.

3. The recording apparatus according to claim 2, wherein
a length from one end portion of the housing to the movable unit in the second direction is longer than a length from an end portion of the housing on the other side of the housing to the movable unit in the second direction.

4. The recording apparatus according to claim 1, wherein
the recording unit includes a recording head and an ink cartridge storage portion in which an ink storage portion for storing ink to be supplied to the recording head is housed, and
when the ink storage portion is stored in a storage unit, an end portion of the ink storage portion on the set position side in the first direction is located on the recording head side with respect to an end portion of the supporting unit on the recording unit side in a case where the supporting unit is located at the set position.

5. The recording apparatus according to claim 4, wherein
the storage unit includes a first storage unit provided on one side and a second storage unit provided on the other side in the second direction, and
the movable unit is located between the first storage unit and the second storage unit in the second direction.

6. The recording apparatus according to claim 4, wherein
the storage unit includes an openable-and-closable cover, and
the openable-and-closable cover in the closed state is located on the recording head side with respect to an end portion of the supporting unit on the recording unit side in the first direction.

7. The recording apparatus according to claim 1, wherein the recording unit includes a see-through portion configured to make an interior thereof visible.

8. The recording apparatus according to claim 7, wherein the see-through portion comprises a transparent openable-and-closable cover.

9. The recording apparatus according to claim 8, wherein a length of the transparent openable-and-closable cover in the second direction is longer than the length of the movable unit in the second direction.
